(19) United States
(12) Patent Application Publication
(10) Pub. No.: US 2019/0285063 A1
(43) Pub. Date: Sep. 19, 2019

(54) REFRIGERANT COMPRESSOR AND FREEZER/REFRIGERATOR INCLUDING SAME

(71) Applicant: Panasonic Appliances Refrigeration Devices Singapore, Singapore (SG)

(72) Inventors: Yasushi HAYASHI, Osaka (JP); Hirotaka KAWABATA, Shiga (JP); Yoshinori ISHIDA, Osaka (JP); Shingo OYAGI, Osaka (JP); Terumasa IDE, Shiga (JP); Akio YAGI, Shiga (JP); Hironari AKASHI, Shiga (JP); Hiroto HAYASHI, Shiga (JP); Kazuhiro YOKOTA, Shiga (JP); Hiroki TORIMASU, Osaka (JP)

(73) Assignee: Panasonic Appliances Refrigeration Devices Singapore, Singapore (SG)

(21) Appl. No.: 16/465,031

(22) PCT Filed: Nov. 28, 2017
(86) PCT No.: PCT/JP2017/042575

§ 371 Date: May 29, 2019

(30) Foreign Application Priority Data
Nov. 29, 2016 (JP) 2016-231272

(51) Int. Cl. F04B 39/02; F04B 17/03; C10M 101/00; C10M 105/06; C10M 105/32; C10M 137/04; C10M 169/04

(52) U.S. Cl. CPC F04B 39/0215; C10N 2240/30; C10M 101/00; C10M 105/06; C10M 105/32; C10M 137/04; C10M 169/04; F05C 2201/0436; C10M 2203/003; C10M 2203/065; C10M 2207/2805; C10M 2223/06; C10N 2230/02; C10N 2230/06; F04B 17/03

(57) ABSTRACT

Inside a sealed container (101) of a refrigerant compressor (100), lubricating oil (103) having a kinematic viscosity at 40° C. of 0.1 mm²/S to 5.1 mm²/S is stored, and an electric element (106) and a compression element (107) are accommodated. The compression element (107) is provided with, as a shaft part, a crankshaft (108) comprising a main shaft (109) and an eccentric shaft (110), and as bearing parts, a main bearing (114) that axially supports the main shaft (109) and an eccentric bearing (119) that axially supports the eccentric shaft (110). At least one surface of the main shaft (109) and the eccentric shaft (110) is subjected to a surface treatment, e.g., formation of an oxide film, having a hardness equal to or greater than that of a bearing part (the main bearing (114) or the eccentric bearing (119)). Satisfactory reliability in sliding parts can thereby be achieved even if lubricating oil having lower viscosity is used.

### TECHNICAL FIELD

The present invention relates to a refrigerant compressor for use in refrigerators, air conditioners, and the like, and a freezer/refrigerator including the refrigerant compressor.

### BACKGROUND ART

Highly efficient refrigerant compressors which reduce the use of fossil fuels from the viewpoint of the protection of the global environment have been developed in recent years. For example, in order to increase the efficiency of the refrigerant compressors, proposed are the formation of various films on sliding surfaces of sliding members included in the refrigerant compressors and the use of lubricating oil having lower viscosity.

For example, the refrigerant compressor includes the sliding members, such as a crank shaft, a piston, and a connecting rod of a coupler (coupling means), and respective sliding portions of the refrigerant compressor are formed by: a main shaft of the crank shaft and a main bearing; the piston and a bore; a piston pin and the connecting rod; an eccentric shaft of the crank shaft and the connecting rod; and the like.

For example, PTL 1 discloses a sliding member formed by: forming a Ti film on the surface of a base material that is a metal material; and forming a non-crystalline hard carbon film having a hydrogen content of 0 atom % as an upper layer of the Ti film. In a sealed compressor including this sliding member, low-viscosity lubricating oil having a viscosity grade of VG10 or less can be used.

PTL 2 discloses a sliding member formed by: reforming structures of a base material of the sliding member; and then forming a phosphate film on the surface of the base material. In a sealed compressor including this sliding member, low-viscosity lubricating oil having a viscosity grade of VG10 or less can be used.

### CITATION LIST

### Patent Literature

PTL 1: Japanese Laid-Open Patent Application Publication No. 2010-025075

PTL 2: Japanese Laid-Open Patent Application Publication No. 2013-217302

### SUMMARY OF INVENTION

### Technical Problem

Recently, a further reduction in the viscosity of the lubricating oil has been considered. However, if the viscosity grade of the lubricating oil is set to be lower than VG10, the reliability of the sliding portions may deteriorate.

The present invention was made to solve the above problems, and an object of the present invention is to provide a refrigerant compressor capable of realizing satisfactory reliability of sliding portions even when lubricating oil having lower viscosity is used, and a freezer/refrigerator including the refrigerant compressor.

### Solution to Problem

To solve the above problems, there is provided a refrigerant compressor which reserves lubricating oil having kinetic viscosity of 0.1 to 5.1 mm²/S at 40 C in a sealed container, and accommodates therein an electric component, and a compression component which is driven by the electric component and compresses a refrigerant. The compression component includes: as a shaft portion, a crank shaft including a main shaft and an eccentric shaft; and as a bearing portion supporting the shaft portion, a main bearing supporting the main shaft and an eccentric bearing supporting the eccentric shaft. A treated surface having hardness equal to or more than hardness of the bearing portion is formed on at least one of a surface of the main shaft and a surface of the eccentric shaft.

According to the above configuration, the high-hardness treated surface is formed on the surface of the main shaft or the surface of the eccentric shaft, or the high-hardness treated surfaces are formed on both the surface of the main shaft and the surface of the eccentric shaft. Therefore, even when the viscosity of the lubricating oil is low, the shaft portion and the bearing portion can be satisfactorily lubricated. With this, the abrasion of the sliding surface of the shaft portion can be satisfactorily suppressed, and therefore, the reliability of the refrigerant compressor can be made further satisfactory.

A freezer/refrigerator according to the present invention includes a refrigerant circuit including the above refrigerant compressor, a heat radiator, a decompressor, and a heat absorber, the refrigerant circuit being configured such that the refrigerant compressor, the heat radiator, the decompressor, and the heat absorber are annularly coupled to one another by pipes.

The above object, other objects, features, and advantages of the present invention will be made clear by the following detailed explanation of preferred embodiments with reference to the attached drawings.

### Advantageous Effects of Invention

By the above configurations, the present invention can achieve the effect of being able to provide the refrigerant compressor capable of realizing satisfactory reliability at the sliding portion even when lubricating oil having low viscosity is used, and a freezer/refrigerator including the refrigerant compressor.

### BRIEF DESCRIPTION OF DRAWINGS

FIG. 1A is a schematic sectional view showing one example of the configuration of a refrigerant compressor according to an embodiment of the present disclosure. FIG. 1B is an enlarged view showing a main shaft and a main bearing which are surrounded by a broken line circle in the refrigerant compressor shown in FIG. 1A.

FIG. 2A is a SEM (scanning electron microscope) image showing a typical configuration of an oxide film as one example of a treated surface formed on the surface of the main shaft of the refrigerant compressor shown in FIG. 1A. FIG. 2B is a TEM (transmission electron microscope) image showing another configuration of the oxide film. FIG. 2C is a TEM (transmission electron microscope) image showing yet another configuration of the oxide film.

FIG. 3A is a TEM (transmission electron microscope) image showing a typical configuration of the oxide film as one example of the treated surface formed on the surface of the main shaft of the refrigerant compressor shown in FIG. 1A. FIG. 3B is a SIM (scanning ion microscope) image showing another configuration of the oxide film.

FIG. 4 is a graph showing a relation between the amount of extreme pressure additive added to lubricating oil used in the refrigerant compressor shown in FIG. 1A and an abrasion loss of the main shaft and main bearing of the refrigerant compressor.

FIG. 5 is a schematic diagram showing one example of the configuration of a freezer/refrigerator including the refrigerant compressor shown in FIG. 1A.

### DESCRIPTION OF EMBODIMENTS

According to the present disclosure, there is provided a refrigerant compressor according to the present disclosure which reserves lubricating oil having kinetic viscosity of 0.1 to 5.1 mm²/S at 40 C in a sealed container, and accommodates therein an electric component, and a compression component which is driven by the electric component and compresses a refrigerant. The compression component includes: as a shaft portion, a crank shaft including a main shaft and an eccentric shaft; and as a bearing portion supporting the shaft portion, a main bearing supporting the main shaft and an eccentric bearing supporting the eccentric shaft. A treated surface having hardness equal to or more than hardness of the bearing portion is formed on at least one of a surface of the main shaft and a surface of the eccentric shaft.

According to the above configuration, the high-hardness treated surface is formed on the surface of the main shaft or the surface of the eccentric shaft, or the high-hardness treated surfaces are formed on both the surface of the main shaft and the surface of the eccentric shaft. Therefore, even when the viscosity of the lubricating oil is low, the shaft portion and the bearing portion can be satisfactorily lubricated. With this, the abrasion of the sliding surface of the shaft portion can be satisfactorily suppressed, and therefore, the reliability of the refrigerant compressor can be made further satisfactory.

The above refrigerant compressor may be configured such that: a base material of the shaft portion is an iron-based material; and the treated surface is an oxide film.

According to the above configuration, since the treated surface is the iron-based oxide film, the hardness of the surface of the shaft portion (the main shaft and/or the eccentric shaft) can be made high, and in addition, the effect of, for example, being able to hold the low-viscosity lubricating oil can also be obtained. With this, the abrasion of the sliding surface of the shaft portion can be satisfactorily suppressed, and therefore, the reliability of the refrigerant compressor can be made further satisfactory.

The above refrigerant compressor may be configured such that the oxide film includes, on an outermost surface thereof, at least one of a portion containing diiron trioxide (Fe₂O₃) and a portion constituted by at least fine crystals.

According to the above configuration, the hardness of the outermost surface of the oxide film becomes high. On this account, the abrasion of the sliding surface of the shaft portion (the main shaft and/or the eccentric shaft) can be satisfactorily suppressed, and therefore, the reliability of the refrigerant compressor can be made further satisfactory.

The above refrigerant compressor may be configured such that a ratio L/D of a length L of the bearing portion to an inner diameter D of the bearing portion falls within a range of 0.10 to 1.20.

According to the above configuration, even when the viscosity of the lubricating oil is low, and the ratio L/D of the bearing portion (the main bearing and/or the eccentric bearing) falls within the above range, the abrasion of the sliding surface of the shaft portion can be satisfactorily suppressed. Therefore, the reliability of the refrigerant compressor can be made further satisfactory.

The above refrigerant compressor may be configured such that the lubricating oil is at least one selected from the group consisting of mineral oil, alkyl benzene oil, and ester oil. The above refrigerant compressor may be configured such that the lubricating oil is the mineral oil or the alkyl benzene oil and contains an extreme pressure additive at 0.5 to 8.0 wt. %. Or, the lubricating oil may be the ester oil and contain an extreme pressure additive at 2.0 to 4.0 wt. %. Further, the extreme pressure additive may be a phosphorus compound.

According to the above configurations, the effect by the addition of the extreme pressure additive can be satisfactorily exhibited regardless of the type of the lubricating oil. On this account, the abrasion of the sliding surface of the shaft portion (the main shaft and/or the eccentric shaft) can be satisfactorily suppressed, and therefore, the reliability of the refrigerant compressor can be made further satisfactory.

The above refrigerant compressor may be configured such that the lubricating oil contains an oily agent.

According to the above configuration, the abrasion of the sliding surface of the shaft portion (the main shaft and/or the eccentric shaft) can be satisfactorily suppressed by the addition of the oily agent, and therefore, the reliability of the refrigerant compressor can be made further satisfactory.

The above refrigerant compressor may be configured such that the electric component is inverter-driven at a plurality of operation frequencies.

Further, the present disclosure includes a freezer/refrigerator including a refrigerant circuit including the above refrigerant compressor, a heat radiator, a decompressor, and a heat absorber, the refrigerant circuit being configured such that the refrigerant compressor, the heat radiator, the decompressor, and the heat absorber are annularly coupled to one another by pipes.

Hereinafter, typical embodiments of the present disclosure will be explained with reference to the drawings. In the following explanation and the drawings, the same reference signs are used for the same or corresponding components, and a repetition of the same explanation is avoided.

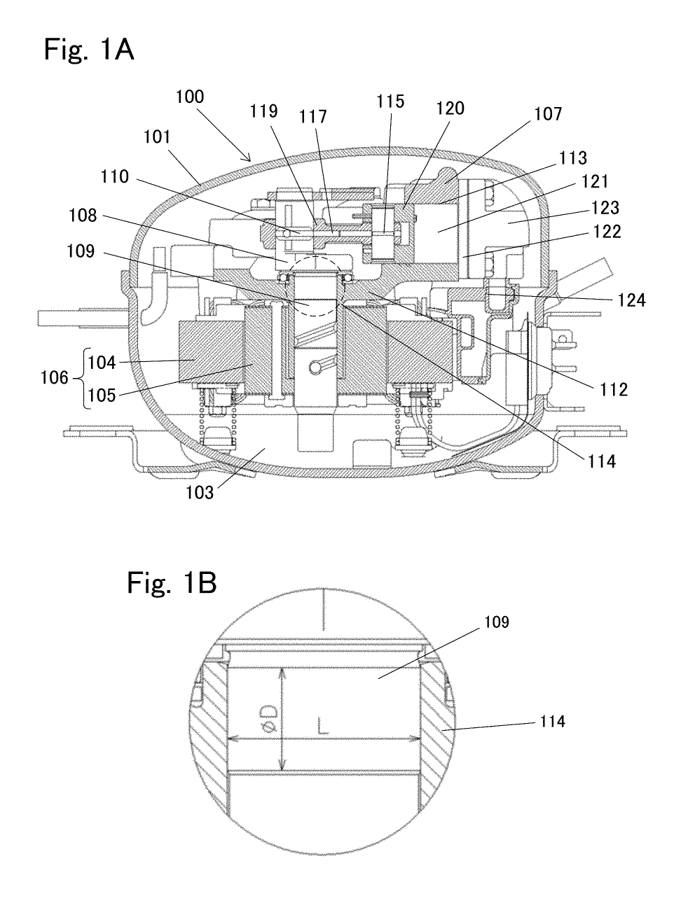

Configuration of Refrigerant Compressor First, a typical configuration example of a refrigerant compressor according to Embodiment 1 of the present disclosure will be specifically explained with reference to FIG. 1A. FIG. 1A is a sectional view of a refrigerant compressor 100 according to Embodiment 1 of the present disclosure.

As shown in FIG. 1A, a sealed container 101 of the refrigerant compressor 100 is filled with, for example, R600a as refrigerant gas, and mineral oil as lubricating oil 103 is stored in a bottom portion of the sealed container 101. The viscosity of the lubricating oil 103 used in the present disclosure is low, i.e., falls within a range of VG0 to VG5 (i.e., grades in which kinetic viscosity at 40° C. falls within a range of 0.1 to 5.1 mm²/S). In Embodiment 1, the lubricating oil 103 is low-viscosity mineral oil. However, as described below, the lubricating oil 103 is not limited to this. Further, as described below, the lubricating oil 103 may contain an extreme pressure additive and/or an oily agent.

An electric component 106 and a compression component 107 are accommodated in the sealed container 101. The electric component 106 is constituted by a stator 104 and a rotor 105. The compression component 107 is a reciprocating type driven by the electric component 106 and includes a crank shaft 108, a cylinder block 112, a piston 120, and the like.

The crank shaft 108 is constituted by a main shaft 109 and an eccentric shaft 110. The main shaft 109 is press-fitted and fixed to the rotor 105. The eccentric shaft 110 is formed eccentrically with respect to the main shaft 109. An oil supply pump (not shown) is provided at a lower end of the crank shaft 108.

In Embodiment 1, the cylinder block 112 is constituted by, for example, cast iron. The cylinder block 112 forms a substantially cylindrical bore 113 and includes a main bearing 114 supporting the main shaft 109 of the crank shaft 108.

The piston 120 is inserted in the bore 113 so as to be able to reciprocate, and with this, a compression chamber 121 is formed. A piston pin 115 has, for example, a substantially cylindrical shape and is arranged parallel to the eccentric shaft 110. The piston pin 115 is locked to a piston pin hole of the piston 120 so as not to be rotatable.

A coupler (coupling means) 117 is constituted by, for example, an aluminum casting and includes an eccentric bearing 119 supporting the eccentric shaft 110. The coupler 117 couples the eccentric shaft 110 and the piston 120 through the piston pin 115. An end surface of the bore 113 is sealed by a valve plate 122.

In the present disclosure, the main shaft 109 and eccentric shaft 110 included in the crank shaft 108 are collectively called a “shaft portion.” The main bearing 114 supporting the main shaft 109 and the eccentric bearing 119 supporting the eccentric shaft 110 are collectively called a “bearing portion.”

A cylinder head 123 forms a high pressure chamber (not shown) and is fixed to the valve plate 122 at an opposite side of the bore 113. A suction tube (not shown) is fixed to the sealed container 101 and connected to a low-pressure side (not shown) of a refrigeration cycle. The suction tube introduces the refrigerant gas into the sealed container 101. A suction muffler 124 is sandwiched between the valve plate 122 and the cylinder head 123.

Respective sliding portions of the refrigerant compressor 100 are formed by: the main shaft 109 of the crank shaft 108 and the main bearing 114; the piston 120 and the bore 113; the piston pin 115 and a connecting rod of the coupler 117; the eccentric shaft 110 of the crank shaft 108 and the eccentric bearing 119 of the coupler 117; and the like.

In the refrigerant compressor 100 configured as above, first, electric power supplied from a commercial power supply (not shown) is supplied to the electric component 106 to rotate the rotor 105 of the electric component 106. The rotor 105 rotates the crank shaft 108, and an eccentric motion of the eccentric shaft 110 drives the piston 120 through the coupler 117 and the piston pin 115. The piston 120 reciprocates in the bore 113, and with this, the refrigerant gas introduced into the sealed container 101 through the suction tube is sucked from the suction muffler 124 and compressed in the compression chamber 121.

A specific method of driving the refrigerant compressor 100 is not especially limited. The refrigerant compressor 100 may be driven by simple on-off control but may be inverter-driven at a plurality of operation frequencies. According to the inverter drive, in order to optimize operation control of the refrigerant compressor 100, a low-speed operation in which the amount of oil supplied to each sliding portion becomes small or a high-speed operation in which the rotational frequency of the electric component 106 increases occurs. As described below, in the refrigerant compressor 100, the abrasion of the main shaft 109 can be satisfactorily suppressed, and therefore, the reliability of the refrigerant compressor 100 can be improved.

Among a plurality of sliding portions included in the refrigerant compressor 100, the main shaft 109 of the crank shaft 108 is rotatably fitted to the main bearing 114 to constitute the sliding portion. Therefore, for convenience of explanation, the sliding portion constituted by the main shaft 109 and the main bearing 114 is referred to as a “main shaft sliding portion.” Similarly, the eccentric shaft 110 of the crank shaft 108 is rotatably fitted to the eccentric bearing 119 to constitute the sliding portion. Therefore, for convenience of explanation, the sliding portion constituted by the eccentric shaft 110 and the eccentric bearing 119 is referred to as an “eccentric shaft sliding portion.” Further, the “main shaft sliding portion” and the “eccentric shaft sliding portion” are collectively called a “shaft portion sliding portion.”

In accordance with the rotation of the crank shaft 108, the lubricating oil 103 is supplied from the oil supply pump to the respective sliding portions. Thus, the sliding portions are lubricated. It should be noted that the lubricating oil 103 serves as a seal between the piston 120 and the bore 113.

Configuration of Shaft Portion Sliding Portion

Next, one example of a specific configuration of the shaft portion sliding portion according to the present disclosure will be specifically explained with reference to FIG. 1B. FIG. 1B is an enlarged view showing the main shaft 109 and the main bearing 114 which are surrounded by a broken line circle in the refrigerant compressor 100 shown in FIG. 1A and shows a length L of the main bearing 114 and an inner diameter D of the main bearing 114. To be specific, FIG. 1B is an enlarged view of the main shaft sliding portion of the shaft portion sliding portion.

When the refrigerant compressor 100 is in a stop state, the rotational speed of the main shaft 109 is 0 m/s. Therefore, the contact state between the main shaft 109 and the main bearing 114 is a metallic contact state. When the refrigerant compressor 100 starts up, the rotational motion starts from the metallic contact state. Therefore, large frictional resistance force acts on the main shaft sliding portion. On this account, in Embodiment 1, a treated surface (surface treatment) having hardness equal to or more than hardness of the main bearing 114 is formed on the surface of the main shaft 109.

Similarly, large frictional resistance force acts on the eccentric shaft sliding portion. Therefore, in Embodiment 1, a treated surface having hardness equal to or more than hardness of the eccentric bearing 119 is formed on the surface of the eccentric shaft 110. In Embodiment 1, the treated surface of the shaft portion is formed on each of the surface of the main shaft 109 and the surface of the eccentric shaft 110. However, the treated surface may be formed only on the surface of the main shaft 109 or the surface of the eccentric shaft 110.

The treated surface formed on the surface of the shaft portion (the main shaft 109 and/or the eccentric shaft 110) is not especially limited as long as the treated surface has hardness at least equal to hardness of the bearing portion (the main bearing 114 and/or the eccentric bearing 119) or hardness equal to or more than hardness of the bearing portion. A preferable example of the treated surface in Embodiment 1 is a below-described oxide film. With this, abnormal abrasion by the metallic contact at the time of the start-up can be prevented. In addition, even when the viscosity of the lubricating oil 103 is low, i.e., falls within a range of VG0 to VG5, the shaft portion and the bearing portion can be satisfactorily lubricated. Therefore, the abrasion of the shaft portion sliding portion can be satisfactorily suppressed. As a result, the reliability of the refrigerant compressor 100 can be further improved.

In the crank shaft 108 including the main shaft 109 and the eccentric shaft 110 in Embodiment 1, gray cast iron (FC cast iron) is used as a base material, and a treated surface (below-described oxide film, for example) is formed on the surface of the base material. The base material of the crank shaft 108 is not limited to gray cast iron and may be a known iron-based material. Typical examples of the base material include general cast irons, such as gray cast iron. However, the base material is not limited to these. The base material may be a steel material, a sintered material, or other iron-based material. The type of the cast iron is not especially limited, and the cast iron may be gray cast iron (plain cast iron, FC cast iron) as described above or may be spheroidal graphite cast iron (FCD cast iron) or other cast iron.

In the shaft portion sliding portion, it is preferable that as in the main shaft sliding portion shown in FIG. 1B, a ratio L/D of the length L of the main bearing 114 to the inner diameter D of the main bearing 114 fall within a range of 0.10 to 1.20. Although not shown, the same is true for the eccentric shaft sliding portion. By reducing the ratio L/D, the sliding loss of the sliding portion can be reduced. However, if the ratio L/D is made too low, an oil film of the lubricating oil 103 is hardly formed on the sliding surface. Especially, the viscosity of the lubricating oil 103 used in the present disclosure is very low. Therefore, if the ratio L/D is made low, a lubricating effect by the lubricating oil 103 may not be adequately obtained.

However, according to the present disclosure, the treated surface, such as the below-described oxide film, having the hardness equal to or more than the hardness of the bearing portion is used at the shaft portion sliding portion of the refrigerant compressor 100. With this, even when the ratio L/D falls within the above range, and the viscosity of the lubricating oil 103 is low, the satisfactory lubricating effect can be realized. Therefore, the reliability of the shaft portion sliding portion can be further improved. It should be noted that the upper limit of the ratio L/D is only required to be 1.20 or less. However, the upper limit of the ratio L/D can be set to 0.45 or less. Therefore, one example of the more preferable range of the ratio L/D is a range of 0.10 to 0.45.

In order to evaluate the high-hardness treated surface such as the below-described oxide film, the following will explain a method of measuring the hardness in the present disclosure.

In the measurement of the hardness of the treated surface (such as the below-described oxide film) of the shaft portion or the hardness of the surface of the bearing portion (i.e., the hardness of a measurement target), a nano indentation apparatus (triboindenter) produced by Scienta Omicron, Inc. can be used. As a specific method of measuring the hardness, performed 15 times is a step in which: an indenter is pressed against the surface to apply a load to the surface for a certain period of time; the application of the load is slightly reduced; and the indenter is again pressed against the surface to apply a load higher than the previous load. Such loading-unloading test is repeated such that the highest load becomes 1 N. With this, the hardness of the measurement target and the hardness of the measurement target in the depth direction can be measured.

The measurement of Vickers hardness of the bearing portion of the shaft portion sliding portion will be explained. A part of an inner peripheral surface of the main bearing 114 of the cylinder block 112 or a part of an inner peripheral surface of the eccentric bearing 119 of the coupler 117 is cut by a fine cutter as a measurement sample. Then, the Vickers hardness of the measurement sample is only required to be measured under a condition of a load of 0.5 kgf.

In Embodiment 1, according to the results of these measurement methods, the treated surface of the shaft portion (at least one of the main shaft 109 and the eccentric shaft 110 in the crank shaft 108) has the hardness equal to or more than the hardness of the bearing portion (at least one of the main bearing 114 and the eccentric bearing 119) that is an opponent sliding member.

The hardness in the present disclosure is one of mechanical properties of especially the surface of a substance or material or the vicinity of the surface of the substance or material. The hardness can be defined as the unlikelihood of the deformation of an object and the unlikelihood of the damage of the object when the material is deformed or damaged by a foreign matter. Regarding the hardness, there are various measurement means (definitions) and their corresponding values (measures of the hardness).

When the sliding members are made of a metal or a nonferrous metal, whether or not the film on the surface of the sliding member is harder than the opponent sliding member can be determined by using the same indentation hardness test method (such as the above-described nano indentation method, the Vickers hardness method, or the Rockwell hardness method).

When a resin film, a phosphate film, or the like is formed on the surface of the sliding member, it is difficult to apply the indentation hardness test method. In this case, for example, a ring-on-disk abrasion test can be used. One example of such evaluation method is a method of observing the state of the sliding surface by: forming a film on the surface of a disk; and rotating the disk at a rotational speed of 1 m/s for about an hour while applying a load of 1000 N to the film with the disk immersed in oil. As a result, it may be determined that the ring or the disk including the film which is larger in abrasion loss has lower hardness.

Configuration of Oxide Film

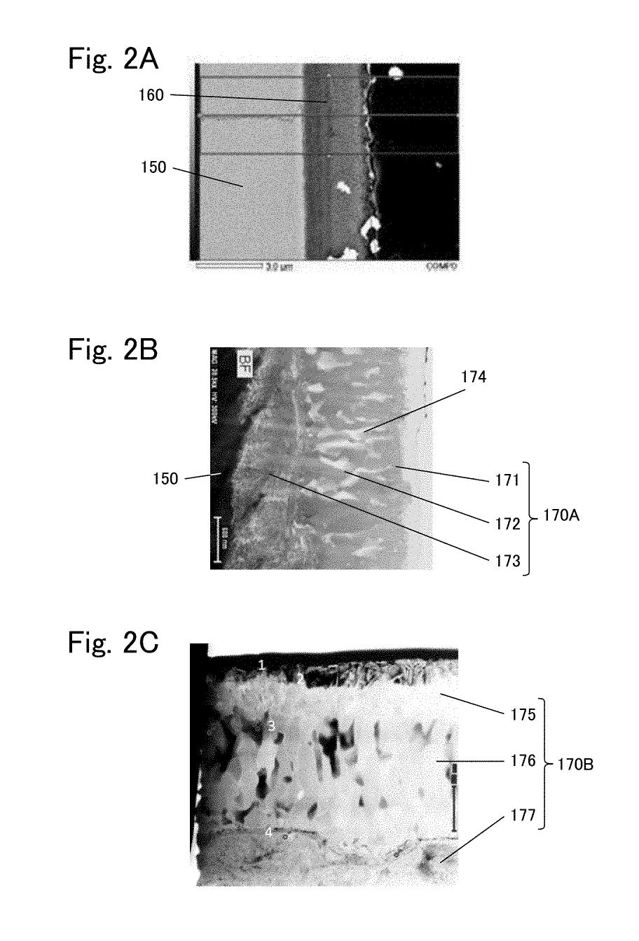

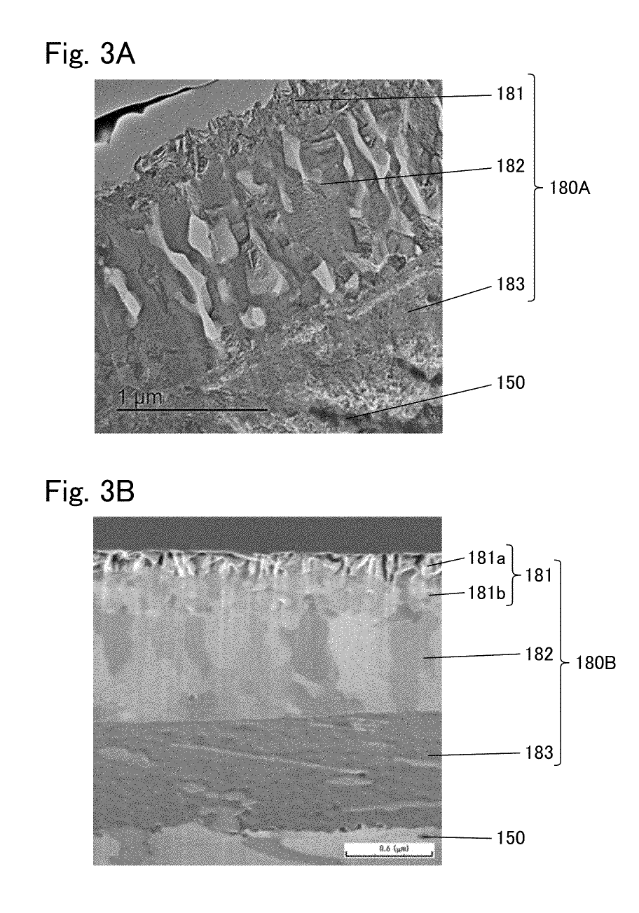

Next, a specific configuration example of the oxide film as an especially typical example of the treated surface formed on the surface of the shaft portion (the main shaft 109 and/or the eccentric shaft 110) of the shaft portion sliding portion according to the present disclosure will be explained in detail with reference to FIGS. 2A to 2C, 3A, and 3B.

FIG. 2A is a SEM (scanning electron microscope) image showing a configuration example of a typical oxide film 160. FIG. 2B is a TEM (transmission electron microscope) image showing the configuration of another typical oxide film 170A. FIG. 2C is a TEM (transmission electron microscope) image showing the configuration of yet another typical oxide film 170B. FIG. 3A is a TEM (transmission electron microscope) image showing a typical configuration of still another typical oxide film 180A. FIG. 3B is a SIM (scanning ion microscope) image showing the configuration of yet another typical oxide film 180B.

In the present disclosure, the base material of the oxide film as the typical example of the high-hardness treated surface formed on the surface of the shaft portion is an iron-based material, and the oxide film is only required to be formed by oxidizing the surface of the iron-based material. One preferable example of the oxide film is configured such that the oxide film includes, on an outermost surface thereof, at least one of a portion containing diiron trioxide (Fe₂O₃) and a portion constituted by at least fine crystals. Examples of the oxide film having such preferable configuration include the oxide films 160, 170A, 170B, 180A, and 180B shown in FIGS. 2A to 3B.

### Configuration Example 1 of Oxide Film

First, the oxide film 160 shown in FIG. 2A will be explained. The oxide film 160 includes the portion containing diiron trioxide (Fe₂O₃) at the outermost surface side. Further, the oxide film 160 includes a silicon-containing portion at a base material 150 side, the silicon-containing portion containing a larger amount of silicon (Si) than the base material 150.

The oxide film 160 may include a spot-shaped silicon-containing portion which is located closer to the surface of the oxide film 160 than the silicon-containing portion and is partially larger in silicon (Si) content than its surroundings. The oxide film 160 may be constituted by at least a portion in which a component contained most is diiron trioxide (Fe₂O₃) and a portion in which a component contained most is triiron tetroxide (Fe₃O₄), which portions are arranged in this order from the outermost surface.

Further, the oxide film 160 may be constituted by at least a portion in which a component contained most is diiron trioxide (Fe₂O₃), a portion in which a component contained most is triiron tetroxide (Fe₃O₄), and a portion in which a component contained most is iron oxide (FeO), which portions are arranged in this order from the outermost surface.

The oxide film 160 will be specifically explained with reference to FIG. 2A. In Embodiment 1, the oxide film 160 is formed on the base material 150 (in FIG. 2A, at the right side of the base material 150) made of spheroidal graphite cast iron (FCD cast iron).

The oxide film 160 was analyzed by energy-dispersive X-ray spectroscopy (EDS). Although specific results are not shown, an iron (Fe) intensity ratio of the oxide film 160 is smaller than that of the base material 150, and the iron (Fe) intensity ratio tends to increase slightly inside the oxide film 160. Further, an oxygen (O) intensity ratio of the oxide film 160 is significantly larger than that of the base material 150. A silicon (Si) intensity ratio of a portion of the oxide film 160 which portion is located close to the base material 150 is larger than that of the base material 150. The silicon (Si) intensity ratio significantly decreases inside the oxide film 160, and the silicon (Si) intensity ratio of a portion of the oxide film 160 which portion is located close to the outermost surface is almost a detection limit or less.

At an initial stage of the oxidation reaction caused when forming the oxide film 160 on the surface of the base material 150, an oxide of iron and silicon, such as fayalite (Fe₂SiO₄), is formed in the vicinity of an interface at the base material 150. It is thought that: the oxide exhibits a so-called iron diffusion barrier function; and as the oxidation reaction proceeds, the oxide creates a state of lack of iron on the surface of the base material 150. With this, it is thought that internal diffusion of oxygen is promoted by the progress of the oxidation reaction.

As a result, it is thought that the oxidation of iron oxide (FeO) formed at the initial stage of the oxidation reaction is accelerated, and therefore, crystal structures, such as diiron trioxide (Fe₂O₃) and/or triiron tetroxide (Fe₃O₄), which contribute to the abrasion resistance are generated in the oxide film 160.

The oxide film 160 shown in FIG. 2A is only required to be constituted by at least a portion in which a component contained most is diiron trioxide (Fe₂O₃) (for convenience sake, this portion is referred to as a “III portion” based on diiron trioxide (Fe₂O₃), i.e., based on “iron(III) oxide.”) and a portion in which a component contained most is triiron tetroxide (Fe₃O₄) (for convenience sake, this portion is referred to as a “II-III portion” based on triiron tetroxide (Fe₃O₄), i.e., based on “iron(II) iron(III) oxide.”), which portions are arranged in this order from the outermost surface (sliding surface) (Film Configuration 1).

Or, the oxide film 160 shown in FIG. 2A may be constituted by at least the III portion in which a component contained most is diiron trioxide (Fe₂O₃), the II-III portion in which a component contained most is triiron tetroxide (Fe₃O₄), and a portion in which a component contained most is iron oxide (FeO) (for convenience sake, this portion is referred to as a “II portion” based on iron oxide (FeO), i.e., based on “iron(II) oxide.”), which portions are arranged in this order from the outermost surface (sliding surface) (Film Configuration 2).

In both Film Configurations 1 and 2 of the oxide film 160, the major component of the III portion on the outermost surface is diiron trioxide (Fe₂O₃), and the II-III portion in which the major component is triiron tetroxide (Fe₃O₄) is located under the III portion. Since triiron tetroxide (Fe₃O₄) is a cubic crystal stronger than diiron trioxide (Fe₂O₃) in terms of the crystal structure, the III portion is supported by the II-III portion as a lower layer.

In Film Configuration 2 of the oxide film 160, the II portion in which the major component is iron oxide (FeO) is located under the II-III portion. Since iron oxide (FeO) exists at the interface on the surface of the base material 150 in an amorphous state not including the crystal structure, the existence of weak structures, such as a crystal grain boundary and a lattice defect, can be adequately suppressed. Therefore, the proof stress of the oxide film 160 with respect to the load applied when the sliding member slides improves. As a result, this may contribute to the suppression of the separation of the oxide film 160 and the improvement of the adhesive force of the oxide film 160 with respect to the base material 150.

Based on the silicon (Si) content, the II-III portion can be divided into a portion which is located close to the surface and small in silicon (Si) content and a portion which is located close to the base material 150 and small in silicon (Si) content. For convenience sake, the upper portion which is small in silicon (Si) content is referred to as a “II-III-a portion,” and the lower portion which is large in silicon (Si) content is referred to as a “II-III-b portion.” The interface between the portion and the II-III-b portion coincides with a portion where the silicon (Si) intensity ratio significantly decreases inside the oxide film 160 according to the above-described EDS analysis.

Although not shown, the portion(s) (the II-III portion, or the II-III portion and the II portion) of the oxide film 160 which portion(s) is located close to the base material 150 is a silicon-containing portion(s) larger in silicon (Si) content than the base material 150. Further, although not shown, in the oxide film 160, the portion (at least one of the II-III portion and the III portion) located closer to the surface than the silicon-containing portion contains a spot-shaped silicon-containing portion which is partially larger in silicon (Si) content than its peripheral composition. Since the spot-shaped silicon-containing portion is observed as a while spot with, for example, a TEM (transmission electron microscope), the spot-shaped silicon-containing portion may be referred to as a “white portion.” In this “white portion,” an increase in silicon (Si) concentration or strength is observed.

Especially, in the II-III portion, the upper portion is lower in silicon (Si) content than the lower II-III-b portion (silicon-containing portion). However, the “white portion,” i.e., the spot-shaped silicon-containing portion is contained inside the portion. Similarly, in the oxide film 160 shown in FIG. 2A, the III portion located close to the outermost surface hardly contains silicon (Si), but the “white portion,” i.e., the spot-shaped silicon-containing portion can be made to exist in the III portion by adjusting conditions.

In the spot-shaped silicon-containing portion, there exist silicon (Si) compounds, such as silicon dioxide (SiO₂) and/or fayalite (Fe₂SiO₄), which are different in structure from each other. Further, in the “white portion,” there may exist silicon (Si) in a solid solution state (exist silicon (Si) as a simple substance) instead of the silicon (Si) compound. Therefore, in the III portion and/or the portion, there may exist, as the spot-shaped silicon-containing portion, not only the portion containing the silicon (Si) compound but also the silicon (Si) solid solution portion.

The oxide film 160 is only required to include at least the lamellar silicon-containing portion (a part of the II-III portion, the II portion, etc.) located close to the base material 150. Preferably, the oxide film 160 is only required to include the spot-shaped silicon-containing portion which is located at a position closer to the surface than the silicon-containing portion and is larger in silicon (Si) content than its surroundings. As described above, examples of the specific configuration of the oxide film 160 include Film Configuration 1 including the III portion and the II-III portion and Film Configuration 2 including the III portion, the II-III portion, and the II portion. However, the configuration of the oxide film 160 is not limited to these.

As described above, a preferable example of the oxide film 160 is formed such that the III portion, the portion, and the II-III-b portion (and the II portion) are laminated in this order from the outermost surface. However, the configuration of the oxide film 160 is not limited to the three-layer configuration and the four-layer configuration. The oxide film 160 may contain other layer(s), or one or more of the layers of the oxide film 160 may be omitted or replaced. As above, regarding the oxide film 160, the configuration including other layer(s), the configuration from which one or more layers are omitted, and the configuration in which the order of the layers laminated is made different can be easily realized by adjusting the below-described conditions.

### Configuration Example 2 of Oxide Film

Next, the oxide film 170A shown in FIG. 2B and the oxide film 170B shown in FIG. 2C will be explained. Each of the oxide films 170A and 170B includes: a composition-A portion in which a component contained most is diiron trioxide (Fe₂O₃); a composition-B portion in which a component contained most is triiron tetroxide (Fe₃O₄) and which contains a silicon (Si) compound; and a composition-C portion in which a component contained most is triiron tetroxide (Fe₃O₄) and which is larger in silicon content than the composition-B portion.

As shown in FIGS. 2B and 2C, the oxide film 170A may be constituted by at least an outermost portion 171 as the composition-A portion, an intermediate portion 172 as the composition-B portion, and an inner portion 173 as the composition-C portion, which portions are arranged in this order from the outermost surface, and the oxide film 170B may be constituted by at least an outermost portion 175 as the composition-A portion, an intermediate portion 176 as the composition-B portion, and an inner portion 177 as the composition-C portion, which portions are arranged in this order from the outermost surface.

In the oxide films 170A and 170B, the silicon (Si) compound may also be contained in the composition-A portion. The silicon (Si) compound is not especially limited and may be at least one of silicon dioxide (SiO₂) and fayalite (Fe₂SiO₄).

First, the oxide film 170A shown in FIG. 2B will be specifically explained. As shown in FIG. 2B, the oxide film 170A is formed on the base material 150 (in FIG. 2B, at the right side of the base material 150) that is, for example, gray cast iron (FC cast iron). It is clearly confirmed that as described above, the oxide film 170A has a three-portion structure (three-layer structure) in which the outermost portion 171 (first layer), the intermediate portion 172 (second layer), and the inner portion 173 (third layer) are arranged in this order from the outermost surface. It is also confirmed that white portions 174 partially exist in the intermediate portion 172 that is the second layer.

Further, the oxide film 170A was by the EDS in the same manner as the above analysis of the oxide film 160. Although specific results are not shown, elements of iron (Fe) and oxygen (O) exist entirely from the outermost portion 171 to the inner portion 173 in the oxide film 170A. However, silicon (Si) hardly exists in the outermost portion 171, or the amount of silicon (Si) in the outermost portion 171 is small. Further, silicon (Si) exists in a part of the intermediate portion 172 and a most part of the inner portion 173.

Further, in the white portion 174 included in the intermediate portion 172, there exists oxygen (O) which does not combine with iron (Fe) but combines with silicon (Si) and also exists oxygen (O) which combines with both iron (Fe) and silicon (Si). Therefore, in the white portion 174, there exist plural types of silicon (Si) compounds, such as silicon dioxide (SiO₂) and fayalite (Fe₂SiO₄), which are different in structure from one another.

Next, the oxide film 170B shown in FIG. 2C will be specifically explained. As shown in FIG. 2C, it is clearly confirmed that the oxide film 170B is formed on the base material 150 (not shown), and as with the oxide film 170A, the oxide film 170B has a three-portion structure (three-layer structure) in which the outermost portion 175 (first layer), the intermediate portion 176 (second layer), and the inner portion 177 (third layer) are arranged in this order from the outermost surface.

As with the outermost portion 171 of the oxide film 170A, the outermost portion 175 is the composition-A portion, and a component contained most in the outermost portion 175 is diiron trioxide (Fe₂O₃). As with the intermediate portion 172 of the oxide film 170A, the intermediate portion 176 is the composition-B portion. A component contained most in the intermediate portion 176 is triiron tetroxide (Fe₃O₄), and the intermediate portion 176 also contains the silicon (Si) compound. As with the inner portion 173 of the oxide film 170A, the inner portion 177 is the composition-C portion. A component contained most in the inner portion 177 is triiron tetroxide (Fe₃O₄), and the inner portion 177 is larger in silicon content than the composition-B portion.

Especially, silicon (Si) of the oxide film 170B was analyzed by the EDS. Although specific results are not shown, the concentration of silicon (Si) is high in the base material 150, and the concentration of silicon (Si) is high also in the inner portion 177 of the oxide film 170B, the inner portion 177 being located close to the base material 150. On the other hand, the concentration of silicon (Si) significantly decreases at the interface between the inner portion 177 and the intermediate portion 176.

Although not clearly shown in FIG. 2C, the white portion 174 exists in the intermediate portion 176 as with the intermediate portion 172 of the oxide film 170A. According to the analysis by the EDS, an increase in silicon (Si) concentration is observed at a portion corresponding to the white portion 174. Further, although silicon (Si) is hardly confirmed in the outermost portion 171 of the oxide film 170A, the white portion 174 is confirmed in the outermost portion 175 of the oxide film 170B, and an increase in silicon (Si) concentration is observed at a portion corresponding to the white portion 174. Further, the existence of silicon (Si) in the oxide film 170B was analyzed by electron-ray energy loss spectroscopy (EESL). It is confirmed that although not shown, silicon (Si) which combines with oxygen (O) exists at any portion in the oxide film 170B.

To be specific, the oxide film 170B shown in FIG. 2C is basically the same in configuration as the oxide film 170A shown in FIG. 2B. However, the oxide film 170B is different from the oxide film 170A in that the silicon (Si) compounds, such as silicon dioxide (SiO₂), exist not only in the inner portion 177 and the intermediate portion 176 but also in the outermost portion 175.

As described above, the oxide film 170A shown in FIG. 2B is constituted by at least the outermost portion 171 as the composition-A portion, the intermediate portion 172 as the composition-B portion, and the inner portion 173 as the composition-C portion, which portions are arranged in this order from the outermost surface, and the oxide film 170B shown in FIG. 2C is constituted by at least the outermost portion 175 as the composition-A portion, the intermediate portion 176 as the composition-B portion, and the inner portion 177 as the composition-C portion, which portions are arranged in this order from the outermost surface. However, each of the configurations of the oxide films 170A and 170B is not limited to the three-layer structure.

Each of the oxide films 170A and 170B is only required to include the composition-A portion, the composition-B portion, and the composition-C portion. Therefore, needless to say, each of the oxide films 170A and 170B may contain a composition portion(s) other than the above portions. Each of the configurations of the oxide films 170A and 170B is not limited to the configuration in which the composition-A portion, the composition-B portion, and the composition-C portion are laminated in this order from the outermost surface. One example of each of the configurations of the oxide films 170A and 170B is a configuration in which the composition-B portion, the composition-A portion, and the composition-C portion are laminated in this order from the outermost surface. The configuration including other portion(s) and the configuration in which the order of the portions laminated is made different can be easily realized by adjusting below-described conditions.

### Configuration Example 3 of Oxide Film

Next, the oxide film 180A shown in FIG. 3A and the oxide film 180B shown in FIG. 3B will be explained. Each of the oxide films 180A and 180B includes: a first portion 181 constituted by at least fine crystals; a second portion 182 containing columnar structures; and/or a third portion 183 containing lamellar structures.

A preferable example of each of the oxide films 180A and 180B is constituted by at least the first portion 181 located on the outermost surface, the second portion 182 located under the first portion 181, and the third portion 183 located under the second portion 182.

A crystal grain diameter of the first portion 181 may be smaller than that of the second portion 182. The crystal grain diameter of the fine crystal constituting the first portion 181 is not especially limited but may fall within a range of 0.001 to 1 μm.

As shown in FIG. 3A, in the oxide film 180A, the first portion 181 is constituted by substantially a single portion. However, the configuration of the first portion 181 is not limited to this. As in the oxide film 180B shown in FIG. 3B, the first portion 181 may be constituted by at least a first-a portion 181a and a first-b portion 181b which are different in crystal density from each other. Specific configurations of the first-a portion 181a and the first-b portion 181b are not especially limited. The first portion 181 may be configured such that: the first-a portion 181a is located at the surface side; the first-b portion 181b is located under the first-a portion 181a; and the crystal density of the first-a portion 181a is lower than the crystal density of the first-b portion 181b.

Specific configurations of the first portion 181, the second portion 182, and the third portion 183 are not especially limited. When the first portion 181 includes the first-a portion 181a, the first-a portion 181a may contain vertically long needle structures each of whose aspect ratio falls within a range of 1 to 1000. The second portion 182 may contain vertically long crystal structures each of whose aspect ratio falls within a range of 1 to 20. The third portion 183 may contain laterally long crystal structures each of whose aspect ratio falls within a range of 0.01 to 1.

First, the oxide film 180A shown in FIG. 3A will be specifically explained. As shown in FIG. 3A, the oxide film 180A is constituted by at least the first portion 181, the second portion 182, and the third portion 183, which are arranged in this order from the outermost surface. The first portion 181 is made of fine crystals. The second portion 182 is located under the first portion 181 and contains vertically long columnar structures. The third portion 183 is located under the second portion 182 and contains laterally long lamellar structures. The base material 150 is located under the third portion 183.

In the oxide film 180A, the third portion 183 is located under the second portion 182. The third portion 183 is constituted by structures each having a vertical diameter of several tens of nanometers or less and a lateral diameter of about several hundreds of nanometers. An aspect ratio obtained by dividing the vertical diameter of the structure by the lateral diameter of the structure falls within a range of 0.01 to 0.1, and therefore, the structure is laterally long. Therefore, it is understood that the “laterally long” lamellar structures each having a low aspect ratio are formed in the third portion 183.

In the third portion 183, cementite that is the structure of the base material 150 is confirmed. On the other hand, cementite is not confirmed in the first portion 181 and the second portion 182. Therefore, it is thought that the third portion 183 is formed such that oxygen is diffused in the base material 150 by the oxidation treatment of the base material 150. On the other hand, it is thought that the first portion 181 and the second portion 182 are formed such that oxides grow on the surface of the base material 150.

The oxide film 180A (and the oxide film 180B shown in FIG. 3B) is only required to be constituted by the first portion 181 and at least one of the second portion 182 and the third portion 183. To be specific, by adjusting below-described conditions, each of the oxide films 180A and 180B can be constituted by two layers that are the first portion 181 and the second portion 182 or two layers that are the first portion 181 and the third portion 183. Further, by adjusting below-described conditions, the oxide film 180A (and the oxide film 180B) is constituted by three layers that are the first portion 181, the second portion 182, and the third portion 183 as described above.

Especially, as shown in FIG. 3A, one example of the typical configuration of the oxide film 180A is the three-layer structure in which the first portion 181, the second portion 182, and the third portion 183 are arranged in this order from the outermost surface. However, the oxide film 180A may contain other portion(s), and the order of the portions laminated can be suitably set by adjusting conditions.

The first portion 181 is constituted by the structures of fine crystals. This does not mean that the first portion 181 does not contain structures other than the fine crystals. In the present disclosure, the first portion 181 is substantially constituted by the fine crystals but may contain, for example, other structures as “impurities.” Therefore, the first portion 181 is only required to be constituted by at least the fine crystals, in other words, is only required to contain the fine crystals as major structures, and may contain other structures.

The second portion 182 is only required to contain the columnar structures. The second portion 182 may contain other structures or may be substantially constituted by the columnar structures. Similarly, the third portion 183 is only required to contain the lamellar structures. The third portion 183 may contain other structures or may be substantially constituted by the lamellar structures. The first portion 181, the second portion 182, and the third portion 183 are formed as the oxide film 180A (or the oxide film 180B) on the surface of the base material 150, and with this, are only required to be able to exhibit the hardness equal to or more than the hardness of the bearing portion. Therefore, needless to say, the first portion 181, the second portion 182, and the third portion 183 may contain structures other than the structures essential for these portions.

In the oxide film 180A, the first portion 181 is only required to contain the structures formed by spreading nano-level fine crystals, and the upper limit of the grain diameter of the fine crystal is not limited to 100 nm or less. For example, the grain diameter of the fine crystal is only required to fall within a range of 0.001 μm (1 nm) to 1 μm (1000 nm).

Similarly, in the oxide film 180A, the second portion 182 is only required to be configured such that the innumerable “vertically long” columnar structures each having a high aspect ratio are formed in the same direction. The aspect ratio of the columnar structure is not limited to a range of 3 to 10. For example, the aspect ratio of the columnar structure is only required to fall within a range of 1 to 20.

Similarly, in the oxide film 180A, the third portion 183 is only required to be configured such that the “laterally long” lamellar structures each having a low aspect ratio are formed. The aspect ratio of the lamellar structure is not limited to a range of 0.01 to 0.1. For example, the aspect ratio of the lamellar structure is only required to fall within a range of 0.01 to 1.

Each of the grain diameter of the fine crystal of the first portion 181, the aspect ratio of the columnar structure of the second portion 182, and the aspect ratio of the lamellar structure of the third portion 183 can be set to a preferred range by suitably setting below-described conditions.

Next, the oxide film 180B shown in FIG. 3B will be specifically explained. As shown in FIG. 3B, the oxide film 180B is constituted by at least the first portion 181, the second portion 182, and the third portion 183, which are arranged in this order from the outermost surface. The first portion 181 is made of fine crystals. The second portion 182 is located under the first portion 181 and contains vertically long columnar structures. The third portion 183 is located under the second portion 182 and contains laterally long lamellar structures. The base material 150 is located under the third portion 183. Unlike the oxide film 180A shown in FIG. 3A, the first portion 181 of the oxide film 180B can be divided into the first-a portion 181a and the first-b portion 181b which are different in crystal density from each other.

As with the first portion 181 of the oxide film 180A, the first portion 181 formed on the outermost surface of the oxide film 180B is constituted by the structures formed by spreading the fine crystals each having a grain diameter of 100 nm or less. Since the first portion 181 of the oxide film 180B is substantially constituted by the fine crystals, the first portion 181 of the oxide film 180B can be regarded as a “single layer” as with the first portion 181 of the oxide film 180A. However, from the viewpoint of the density of the fine crystals, the first portion 181 of the oxide film 180B can be divided into the first-a portion 181a located close to the outermost surface and the first-b portion 181b located close to the base material 150 (second portion 182). The first-a portion 181a is lower in crystal density than the first-b portion 181b located under the first-a portion 181a.

Specifically, as shown in FIG. 3B, the first-a portion 181a is constituted by at least the fine crystals and includes void portions (black portions in FIG. 3B) in some places. The first-a portion 181a contains vertically long needle structures each having a minor-axis length of 100 nm or less and an aspect ratio within a range of 1 to 10. On the other hand, the first-b portion 181b located under the first-a portion 181a does not contain so much void portions and needle structures. The first-b portion 181b contains the structures formed by spreading nano-level fine crystals.

In the oxide film 180B, the second portion 182 is located under the first-b portion 181b. The second portion 182 is constituted by the structures each having a vertical diameter of about 500 nm to 1 μm and a lateral diameter of about 100 to 150 nm. An aspect ratio obtained by dividing the vertical diameter of the structure by the lateral diameter of the structure falls within a range of about 3 to 10, and therefore, the structure is vertically long. On this account, the second portion 182 is configured such that the innumerable “vertically long” columnar structures each having a high aspect ratio are formed in the same direction.

In the oxide film 180B, the third portion 183 is located under the second portion 182. The third portion 183 is constituted by the structures each having a vertical diameter of several tens of nanometers or less and a lateral diameter of about several hundreds of nanometers. An aspect ratio obtained by diving the vertical diameter of the structure by the lateral diameter of the structure falls within a range of 0.01 to 0.1, and therefore, the structure is laterally long. On this account, the “laterally long” lamellar structures each having a low aspect ratio are formed in the third portion 183.

In the oxide film 180B, the first portion 181 (the first-a portion 181a and the first-b portion 181b) is only required to contain the structures formed by spreading nano-level fine crystals, and the upper limit of the grain diameter of the fine crystal is not limited to 100 nm or less. As with the first portion 181 of the oxide film 180A, the grain diameter of the fine crystal is only required to fall within a range of 0.001 μm (1 nm) to 1 μm (1000 nm).

It is desirable that the percentage of the void portions in the first-a portion 181a be 10% or more. With this, the oil film can be easily formed on the sliding surface (an “oil holding property” of the sliding surface can be improved), and an opponent attacking property can be more satisfactorily suppressed. On the other hand, it is desirable that the percentage of the void portions in the first-b portion 181b be less than 10%. If the percentage of the void portions is too high, denseness (mechanical strength) of the structure may not be adequately improved, and therefore, the first-b portion 181b may not be able to satisfactorily support the first-a portion 181a, although it depends on comparison with the first-a portion 181a.

Based on the above reasons, for example, a volume occupation percentage (for example, 10%) of the void portions can be used as a boundary value (or a threshold) when dividing the first portion 181 into the first-a portion 181a and the first-b portion 181b.

The first-a portion 181a contains not only the fine crystals but also the vertically long needle structures, and the aspect ratio of the needle structure is not especially limited. The needle structure of the oxide film 180B has a minor-axis length of 100 nm or less and an aspect ratio within a range of 1 to 10, but the aspect ratio may fall within a range of 1 to 1000.

The thickness of each of the oxide films 160 to 180B is not especially limited, but may fall within, for example, a range of 1 to 5 μm. In the oxide films 160 to 180B, a known iron-based material can be suitably used as the base material 150. However, the iron-based material that is the base material 150 may contain silicon within a range of 0.5 to 10% depending on the types of the oxide films 160 to 180B.

Each of the configurations of the oxide films 160 to 180B used as the treated surfaces in the present disclosure is not limited to Configuration Example 1 (oxide film 160), Configuration Example 2 (oxide film 170A, 170B), and Configuration Example 3 (oxide film 180A, 180B). Needless to say, each of the configurations of the oxide films 160 to 180B may be other configuration. Further, as described above, in the oxide films 160 to 180B of the above configuration examples, variations of the specific configurations of the portions, the layers, and the like, variations of the order of the lamination, variations of the thickness, and the like can be realized by suitably adjusting conditions. The conditions are not especially limited, and a typical condition is a method of producing (forming) each of the oxide films 160 to 180B.

A known method of oxidizing an iron-based material can be suitably used as the method of producing each of the oxide films 160 to 180B, but the method of producing each of the oxide films 160 to 180B is not especially limited. Production conditions and the like can be suitably set depending on conditions, such as the type of the iron-based material that is the base material 150, the surface state of the base material 150 (such as the above-described polishing finish), and required physical properties of the oxide films 160 to 180B. In the present disclosure, the gray cast iron as the base material 150 is oxidized by using known oxidizing gas, such as carbon dioxide gas, and a known oxidation facility at several hundreds of degrees Celsius (for example, 400 to 800° C.). With this, each of the oxide films 160 to 180B can be formed on the surface of the base material 150.

Examples of the other conditions include: a specific material as the base material 150 (such as cast iron, a steel material, or a sintered material as described above); components contained in the base material 150 (for example, the content of silicon (Si) in the cast iron or the content of carbon (C) or alloy component in other iron-based material); and the surface state of the base material 150 before the formation of each of the oxide films 160 to 180B (for example, a surface pretreatment). However, the other conditions are not especially limited.

Constitution of Lubricating Oil

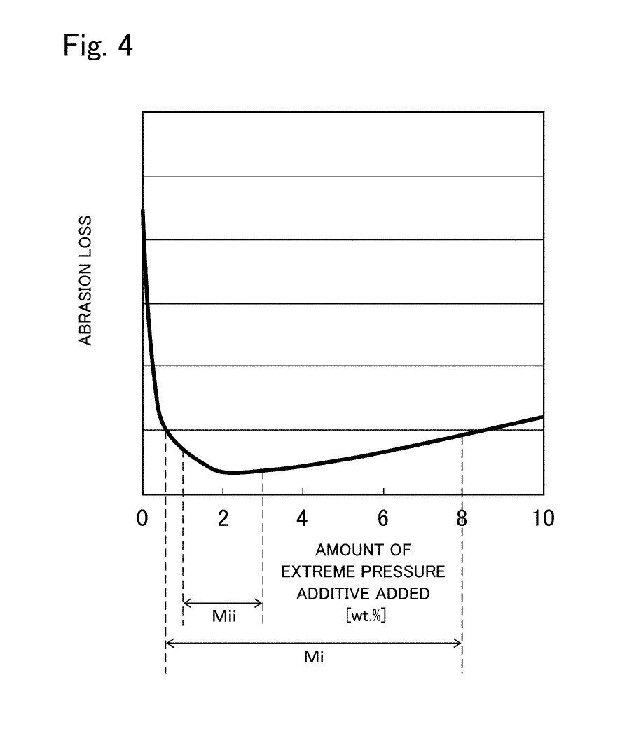

Next, a more specific constitution of the lubricating oil 103 stored in the sealed container 101 will be specifically explained with reference to FIG. 4. FIG. 4 is a graph showing a relation between the amount of extreme pressure additive which can be added to the lubricating oil 103 and the abrasion loss of the main shaft sliding portion (the main shaft 109 and the main bearing 114) of the shaft portion sliding portion of the refrigerant compressor 100.

As described above, in the refrigerant compressor 100 according to the present disclosure, (1) the low-viscosity lubricating oil 103 having viscosity within a range of VG0 to VG5 is used, and (2) the treated surface having the hardness equal to or more than the hardness of the bearing portion is formed on the surface of the shaft portion (as a preferable example, one of the oxide films 160 to 180B is formed). With this, the abrasion of the shaft portion sliding portion can be satisfactorily suppressed, and the reliability of the refrigerant compressor 100 can be made further satisfactory.

Further, in the refrigerant compressor 100 according to the present disclosure, in addition to the above items (1) and (2), as described above, (3) the ratio L/D of the length L of the bearing portion to the inner diameter D of the bearing portion is set within a range of 0.10 to 1.20. With this, the abrasion of the shaft portion sliding portion can be further satisfactorily suppressed, and the reliability of the refrigerant compressor 100 can be made further satisfactory.

In the refrigerant compressor 100 according to the present disclosure, in addition to at least the above items (1) and (2) and preferably the above item (3), (4) a lubricating oil composition used as the lubricating oil 103 is adjusted (especially, the below-described extreme pressure additive and/or oily agent are added). With this, the abrasion of the shaft portion sliding portion can be further satisfactorily suppressed, and the reliability of the refrigerant compressor 100 can be made especially satisfactory.

The lubricating oil composition used as the lubricating oil 103 is only required to contain as a major component an oily substance which satisfies the above item (1), i.e., which is low in viscosity within a range of VG0 to VG5. As a preferable oily substance, at least one selected from the group consisting of mineral oil, alkyl benzene oil, and ester oil can be suitably used. These oily substances may be used alone or in combination of two types or more. The combination of two types or more of oily substances denotes not only, for example, a combination of two types or more of oily substances corresponding to the mineral oil but also, for example, a combination of one or more types of oily substances corresponding to the mineral oil and one or more types of oily substances corresponding to the alkyl benzene oil (or one or more types of oily substances corresponding to the ester oil).

According to the lubricating oil composition used as the lubricating oil 103, various additives may be added to the above one or more types of oily substances. Various additives known in the field of the lubricating oil 103 can be suitably used. Typical examples include an extreme pressure additive, an oily agent, an abrasion preventing agent, an oxidation inhibitor, an acid capturing agent, a metal inactivating agent, an antifoaming agent, a corrosion inhibitor, and a dispersing agent. In the present disclosure, an especially preferable one of these additives is the extreme pressure additive.

The extreme pressure additive is added to the lubricating oil composition (one type of oily substance or two types or more of oily substances) for the purpose of reducing the abrasion of the surfaces (sliding surfaces) of a plurality of sliding members constituting the sliding portion and suppressing seizure of the sliding surfaces. The extreme pressure additive reacts with the sliding surface to form a film on the sliding surface, and with this, the reduction of the abrasion and the suppression of the seizure are realized.

Specifically, a known extreme pressure additive can be suitably used, and the extreme pressure additive is not especially limited. Examples of the extreme pressure additive include: phosphorus compounds such as phosphoric ester; sulfur compounds such as sulfurized fatty acid and its ester; and halogenated compounds such as chlorine-based hydrocarbon and fluorine-based hydrocarbon. These extreme pressure additives may be used alone or in combination of two types or more.

Among these extreme pressure additives, the phosphorus compound can be preferably used. Typical examples of the phosphorus compound include tricresyl phosphate (TCP), tributyl phosphate (TBP), and triphenyl phosphate (TPP). Among these, the TCP can be preferably used.

The amount of extreme pressure additive added to the lubricating oil composition is not especially limited. For example, when the lubricating oil 103 (oily substance) is a low-polarity substance, such as mineral oil or alkyl benzene oil, the amount of extreme pressure additive added to the lubricating oil composition is preferably within a range of 0.5 to 8.0 wt. % and more preferably within a range of 1 to 3 wt. %.

Specifically, as described above, the graph of FIG. 4 shows a relation between the amount of extreme pressure additive added and the abrasion loss of the main shaft sliding portion (shaft portion sliding portion) when the oily substance of the lubricating oil composition is the low-polarity substance, such as mineral oil. It should be noted that the abrasion loss of the main shaft sliding portion (shaft portion sliding portion) is evaluated by a known falex type friction tester.

As shown in FIG. 4, even when the amount of extreme pressure additive added is slight, the abrasion loss of the main shaft sliding portion (shaft portion sliding portion) can be adequately reduced as compared to when the extreme pressure additive is not added (the amount added is 0 wt. %). Especially, when the amount of extreme pressure additive added falls within a range of 0.5 wt. % or more and 8 wt. % or less, the abrasion loss can be significantly reduced, as shown in a range Mi in FIG. 4. When the amount of extreme pressure additive added is less than 0.5 wt. %, the effect of reducing the abrasion loss is inadequate as shown in FIG. 4. When the amount of extreme pressure additive added exceeds 8 wt. %, the abrasion loss reducing effect corresponding to the added amount cannot be obtained, and in addition, the abrasion loss tends to slightly increase by the increase in the added amount.

Especially, the graph of FIG. 4 shows a curved line including a minimal value around the added amount of 2 wt. %. Therefore, it is thought that the especially satisfactory effect of reducing the abrasion loss can be obtained when the amount of extreme pressure additive added falls within a range of 2 wt. %±1 wt. %, i.e., within a range of 1 wt. % or more and 3 wt. % or less, as shown by a range Mii in FIG. 4.

Further, in the present disclosure, when the lubricating oil 103 (oily substance) is the ester oil, the extreme pressure additive can be added within a range of 2.0 to 4.0 wt. %. Since the ester oil is an oily substance having a polarity, the ester oil is easily adsorbed by the iron-based material. Therefore, even when the extreme pressure additive is added to the lubricating oil composition (lubricating oil 103) containing the ester oil, the ester oil is adsorbed by the sliding surface before the extreme pressure additive is adsorbed. Thus, it is difficult for the extreme pressure additive to react with the sliding surface to form the film. On this account, typically, the extreme pressure additive is not added to the lubricating oil 103 (lubricating oil composition) containing the ester oil as a major component.

However, in the present disclosure, as described above, the refrigerant compressor 100 satisfies at least the above items (1) and (2), and especially regarding the item (2), the oxide films 160 to 180B are suitably used. By forming the oxide film (any one of the oxide films 160 to 180B) on the sliding surface of the shaft portion constituting the shaft portion sliding portion, the effect of, for example, reducing the abrasion by the extreme pressure additive can be satisfactorily exhibited even when the low-viscosity lubricating oil 103 satisfying the item (1) is the lubricating oil composition containing the ester oil as the major component.

As above, in the present disclosure, the low-viscosity lubricating oil 103 is used, and the high-hardness treated surface (such as the oxide films 160 to 180B) is formed on the surface of the shaft portion constituting the shaft portion sliding portion. With this, the effect by the extreme pressure additive can be satisfactorily realized regardless of the type of the lubricating oil 103. Therefore, in the shaft portion sliding portion, the ratio L/D of the length L of the bearing portion to the inner diameter D of the bearing portion can be made lower than before (above item (3)), so that the reliability of the refrigerant compressor 100 can be made further satisfactory.

An oily agent may be added to the lubricating oil 103. As described above, the high-hardness treated surface, such as the oxide films 160 to 180B, is formed on the sliding surface of the shaft portion sliding portion. Since a film can be formed on the sliding surface by the addition of the oily agent, the effect of reducing the abrasion by the oily agent can be made further satisfactory by the treated surface.

A specific type of the oily agent is not especially limited, and examples of the oily agent include higher fatty acid, higher alcohol, ester, and metallic soap. These oily agents may be used alone or in combination of two types or more. The amount of oily agent added is not especially limited and may fall within, for example, a range of 0.01 to 1 wt. %. It is preferable that at least one type of extreme pressure additive be added to the lubricating oil 103 (lubricating oil composition). Further, at least one type of oily agent can be added. However, only the oily agent may be added without adding the extreme pressure additive. The same is true for the other additives.

### Embodiment 2

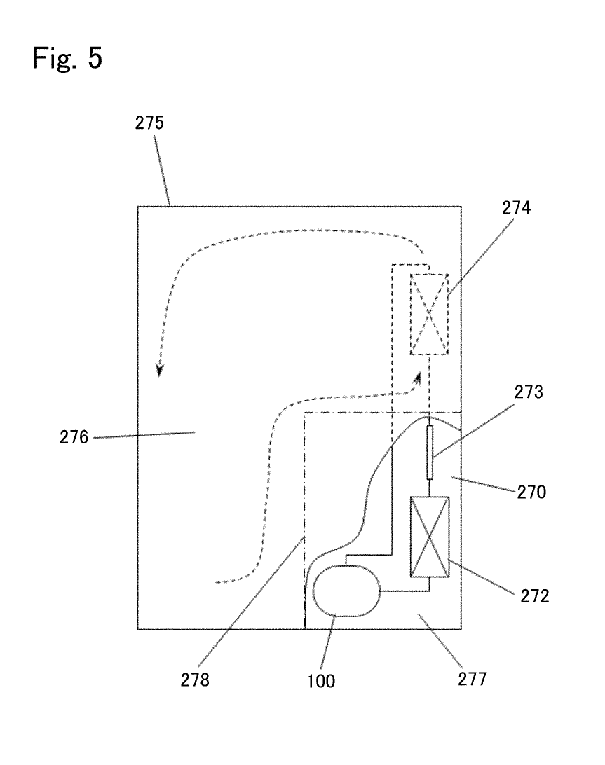

In Embodiment 2, one example of a freezer/refrigerator including the refrigerant compressor 100 explained in Embodiment 1 will be specifically explained with reference to FIG. 5. FIG. 5 schematically shows the configuration of the freezer/refrigerator including the refrigerant compressor 100 according to Embodiment 1. Therefore, in Embodiment 2, only the basic configuration of the freezer/refrigerator will be schematically explained.

As shown in FIG. 5, the freezer/refrigerator according to Embodiment 2 includes a main body 275, a partition wall 278, a refrigerant circuit 270, and the like. The main body 275 is constituted by a heat-insulation box body, a door body, and the like. The box body includes an opening on one surface thereof, and the door body opens and closes the opening of the box body. The inside of the main body 275 is divided by the partition wall 278 into a storage space 276 for articles and a machine room 277. A blower (not shown) is provided in the storage space 276. It should be noted that the inside of the main body 275 may be divided into, for example, spaces other than the storage space 276 and the machine room 277.

The refrigerant circuit 270 is configured to cool the inside of the storage space 276 and includes, for example, the refrigerant compressor 100 explained in Embodiment 1, a heat radiator 272, a decompressor 273, and a heat absorber 274. The refrigerant compressor 100, the heat radiator 272, the decompressor 273, and the heat absorber 274 are annularly connected to one another by pipes. The heat absorber 274 is arranged inside the storage space 276. As shown by broken line arrows in FIG. 5, cooling heat of the heat absorber 274 is stirred by the blower (not shown) so as to circulate in the storage space 276. With this, the inside of the storage space 276 is cooled.

As explained in Embodiment 1, according to the refrigerant compressor 100 included in the refrigerant circuit 270, (1) the viscosity of the lubricating oil 103 is low, i.e., falls within a range of VG0 to VG5, (2) the treated surface having the hardness equal to or more than the hardness of the bearing portion is formed on the surface of the shaft portion (as a preferable example, one of the oxide films 160 to 180B is formed), (3) the ratio L/D of the length L of the bearing portion to the inner diameter D of the bearing portion can be made lower than before, and (4) the effect of reducing the abrasion by the addition of the extreme pressure additive (and/or the oily agent) can be made further satisfactory. With this, the reliability of the refrigerant compressor 100 can be made further satisfactory.

As above, the freezer/refrigerator according to Embodiment 2 includes the refrigerant compressor 100 according to Embodiment 1. The sliding portion included in the refrigerant compressor 100 excels in abrasion resistance and adhesion to the sliding surface. Therefore, the sliding loss of the sliding portion can be reduced, and the refrigerant compressor 100 can realize excellent reliability and excellent efficiency. As a result, the freezer/refrigerator according to Embodiment 2 can reduce the power consumption, and therefore, energy saving can be realized, and the reliability can also be improved.

The present invention is not limited to the above described embodiments and may be changed in various ways within the scope of the claims, and embodiments obtained by suitably combining technical means disclosed in different embodiments and/or plural modified examples are included in the technical scope of the present invention.

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the scope of the present invention.

### INDUSTRIAL APPLICABILITY

As above, the present invention can provide a refrigerant compressor which excels in reliability while using low-viscosity lubricating oil, and a freezer/refrigerator including the refrigerant compressor. Therefore, the present invention is widely applicable to various apparatuses utilizing a refrigeration cycle.

### REFERENCE SIGNS LIST

100 refrigerant compressor
101 sealed container
103 lubricating oil
106 electric component
107 compression component
108 crank shaft
109 main shaft (shaft portion)
110 eccentric shaft (shaft portion)
112 cylinder block
114 main bearing (bearing portion)
119 eccentric bearing (bearing portion)
150 base material
160 oxide film
170A oxide film
170B oxide film
180A oxide film
180B oxide film
270 refrigerant circuit
272 heat radiator
273 decompressor
274 heat absorber

1. A refrigerant compressor which reserves lubricating oil having kinetic viscosity of 0.1 to 5.1 mm²/S at 40 C in a sealed container, and accommodates therein an electric component, and a compression component which is driven by the electric component and compresses a refrigerant, wherein:
the compression component includes
as a shaft portion, a crank shaft including a main shaft and an eccentric shaft and
as a bearing portion supporting the shaft portion, a main bearing supporting the main shaft and an eccentric bearing supporting the eccentric shaft; and
a treated surface having hardness equal to or more than hardness of the bearing portion is formed on at least one of a surface of the main shaft and a surface of the eccentric shaft.

2. The refrigerant compressor according to claim 1, wherein:
a base material of the shaft portion is an iron-based material; and
the treated surface is an oxide film.

3. The refrigerant compressor according to claim 2, wherein the oxide film includes, on an outermost surface thereof, at least one of a portion containing diiron trioxide (Fe₂O₃) and a portion constituted by at least fine crystals.

4. The refrigerant compressor according to claim 1, wherein a ratio L/D of a length L of the bearing portion to an inner diameter D of the bearing portion falls within a range of 0.10 to 1.20.

5. The refrigerant compressor according to claim 1, wherein the lubricating oil is at least one selected from the group consisting of mineral oil, alkyl benzene oil, and ester oil.

6. The refrigerant compressor according to claim 5, wherein the lubricating oil is the mineral oil or the alkyl benzene oil and contains an extreme pressure additive at 0.5 to 8.0 wt. %.

7. The refrigerant compressor according to claim 5, wherein the lubricating oil is the ester oil and contains an extreme pressure additive at 2.0 to 4.0 wt. %.

8. The refrigerant compressor according to claim 6, wherein the extreme pressure additive is a phosphorus compound.

9. The refrigerant compressor according to claim 1, wherein the lubricating oil contains an oily agent.

10. The refrigerant compressor according to claim 1, wherein the electric component is inverter-driven at a plurality of operation frequencies.

11. A freezer/refrigerator comprising a refrigerant circuit including the refrigerant compressor according to claim 1, a heat radiator, a decompressor, and a heat absorber, the refrigerant circuit being configured such that the refrigerant compressor, the heat radiator, the decompressor, and the heat absorber are annularly coupled to one another by pipes.
